(19) United States
(12) Patent Application Publication
(10) Pub. No.: US 2007/0139564 A1
(43) Pub. Date: Jun. 21, 2007

(54) System and method for global indication of mpeg impairments in compressed digital video

(75) Inventors: Lilla Boroczky, Mount Kisco, NY (US); Cornelis Conradus Adrianus Maria Van Zon, Cold Springs, NY (US); Yibin Yang, Pine Brook, NJ (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/598,203

(22) PCT Filed: Feb. 27, 2004
(86) PCT No.: PCT/IB05/50665

§ 371 Date: Aug. 21, 2006

Related U.S. Application Data
(60) Provisional application No. 60/548,672, filed on Feb. 27, 2004.

(51) Int. Cl. H04N 5/21

(52) U.S. Cl. 348/626

(57) ABSTRACT

A method of determining processing a coded video signal includes decoding the coded video signal; determining a global indicator value for a frame from the decoded video; and providing video processing to the decoded video of the frame based on the global indicator. Additionally, an apparatus for processing coded digital video signals includes a coded video decoder; a metric calculation module; and a video processing module, wherein the metric calculation module calculates at least one value of a global indicator, which indicates the quality of the coded video signal, and where the metric calculation module provides the global indicator to the video processing module, which selectively addresses the coded video signal depending on the value.

The present application claims priority under 35 U.S.C. § 120 and 35 USC § 365(c) from International Patent Application serial number IB2003/0057 filed on Dec. 4, 2003 and entitled “A Unified Metric For Digital Video Processing (UMDVP),” to Boroczky, et al. This application is assigned to the present assignee. The disclosure of this application is specifically incorporated herein by reference.

Compressed digital video sources have come into modern households through digital terrestrial broadcast, digital cable/satellite, PVR (Personal Video Recorder), DVD, etc. The emerging digital video products are bringing revolutionary experiences to consumers. At the same time, they are also creating new challenges for video processing functions. For example, low bit rates are often chosen to achieve bandwidth efficiency. The lower the bit rates, the more objectionable become the impairments introduced by the compression encoding and decoding processing.

For digital terrestrial television broadcasting of standard-definition video, a bit rate of approximately 6 Mbit/s is considered a good compromise between picture quality and transmission bandwidth efficiency. (Further details of this may be found in “MPEG-2 Video Compressions,” IEEE Electronics & Communication Engineering Journal, December 1995, pp. 257-264.) However, broadcasters sometimes choose bit rates far lower than 6 Mbit/s to have more programs per multiplex. Meanwhile, many processing functions fail to take the digital compression into account. As a result, they may perform sub-optimally on the compressed digital video.

MPEG-2 has been widely adopted as a digital video compression standard, and is the basis of new digital television services. Metrics for directing individual MPEG-2 post-processing techniques have been developed. One such metric is defined in the article “A New Enhancement Method for Digital Video Applications”, IEEE Transactions on Consumer Electronics, Vol. 48, No. 3, August 2002, pp. 435-443. In this article, a usefulness metric (UME: Usefulness Metric for Enhancement) is defined for improving the performance of sharpness enhancement methods for post-processing of decoded compressed digital video. However, a complete digital video post-processing system must include not only sharpness enhancement but also resolution enhancement and artifact reduction. UME's and other metrics' focus on sharpness enhancement alone limits their usefulness.

Picture quality is one of the most important aspects for digital video products (e.g., DTV, DVD, DVD record, etc.). These products receive and/or store video resources in MPEG-2 format. The MPEG-2 compression standard employs a block-based DCT transform and is a lossy compression that can result in coding artifacts that reduce picture quality. The most common and visible of these coding artifacts are blockiness and ringing. Among the video post-processing functions performed in these products are sharpness enhancement or resolution enhancement, which consists of upscaling and sharpness enhancement; and MPEG-2 artifact reduction are the important functions for quality improvement. It is beneficial for these two functions not to cancel out each other's effects. For instance, MPEG-2 blocking artifact reduction tends to blur the picture while sharpness enhancement makes the picture sharper. If the interaction between these two functions is ignored, the end result may be to restore the blocking effect by the sharpness enhancement even though the early blocking artifact reduction operation reduced the block effect.

Blockiness manifests itself as visible discontinuities at block boundaries due to the independent coding of adjacent blocks. Ringing is most evident along high contrast edges in areas of generally smooth texture and appears as ripples extending outwards from the edge. Ringing is caused by abrupt truncation of high frequency DCT components, which play significant roles in the representation of an edge.

Certain known metrics are useful in providing the requisite information to provide video enhancement, and to address artifact reduction, and other potential sources of video degradation. However, determination of these known metrics requires exceedingly complex calculation techniques. As such, video quality enhancement using these techniques is normally reserved for more costly components.

What is needed, therefore, is a method and apparatus for determining a metric of the video quality of a signal that addresses at least the shortcomings of the known techniques referenced above.

In accordance with an example embodiment a method of determining processing a coded video signal includes decoding the coded video signal; determining a global indicator value for a frame from the decoded video; and providing video processing to the decoded video of the frame based on the global indicator.

In accordance with another example embodiment an apparatus for processing coded digital video signals includes a coded video decoder; a metric calculation module; and a video processing module, wherein the metric calculation module calculates at least one value of a global indicator, which indicates the quality of the coded video signal, and wherein the metric calculation module provides the global indicator value to the video processing module, which selectively addresses the coded video signal depending on the value.

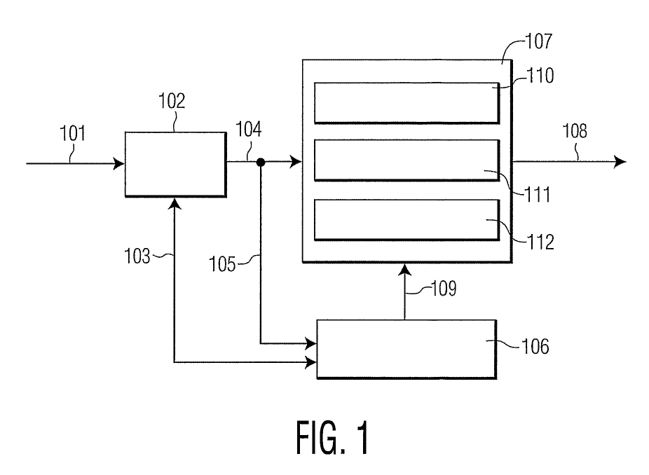

FIG. 1 is a schematic block diagram of a video processing system in accordance with an example embodiment.

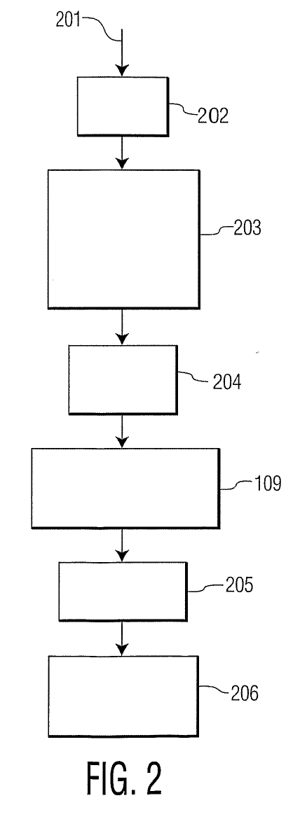

FIG. 2 is a flowchart of a method of processing coded video in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the present invention. Such methods and apparati and methods are clearly within the contemplation of the inventors in carrying out the example embodiments. Wherever possible, like numerals refer to like features throughout.

Briefly, example embodiments are drawn to a method and apparatus of processing coded video. The example embodiments include calculating a metric, which is indicative of the quality of the video signal in a frame. Illustratively, the metric is referred to as a global indicator per frame (referred to herein as GI_{frame} or GI), and may be comprised of one or more coding parameters, which quantify the quality of the video signal. Three coding parameters illustratively are used in the example embodiments to calculate the GI. The first is the quantization parameter (q_scale); and the second is the number of bits spent to code a luminance block (num_bits). The q_scale is the quantization scale for each 16×16 pixel macroblock. This parameter can readily be extracted from the coded video bitstream. Moreover, the num_bits for each 8×8 block can be determined readily from the decoded bitstream with little computational cost. Finally, it is noted that the number of bits spent to code a chrominance block may also be used to calculate the GI.

As described in further detail herein, in one example embodiment, the GI is inversely proportional to the q_scale. In another example embodiment, the GI is inversely proportional to the sum of the q_scale values for a number of macroblocks across the frame. It is noted that the number of macroblocks may comprise the entire frame or may be only a portion thereof. Moreover, in other example embodiments, the GI may be proportional to the num_bits. In still other example embodiments, the GI may be proportional to the sum of the num_bits for a number of blocks that make up the frame. Again, the number of blocks may comprise the entire frame, or may be only a portion thereof.

Before describing certain example embodiments, it is noted that the video compression technology of the example embodiments is illustratively MPEG-2. However, other compression technologies are useful in carrying out the example embodiments. These compression technologies illustratively include MPEG-1, MPEG-4 and MPEG-7, to name only a few. In general, in keeping with example embodiments, a metric may be calculated and used to characterize a frame in a relatively simple manner. As such, a variety of video compression technologies may benefit from the example embodiments. Additionally, it is noted that the coding parameters, num_bits and q_scale, used to calculate GI in the example embodiments are merely illustrative. As such, other coding parameters useful in quantifying the quality of a decoded video signal may be used. Finally, it is noted that the methods and devices described herein can be implemented in either software or hardware, or a combination of hardware and software may be used to achieve a desired performance level.

FIG. 1 is a schematic block diagram of a video processing system 100 in accordance with an example embodiment. In the example embodiment, the coded/processed video format is illustratively MPEG-2 , and the modules of the system are for processing MPEG-2 signals. However, as referenced above, other types of coding may be employed within the purview of the example embodiments. As such, while a decoder module is labeled or referred to as an MPEG-2 decoder, it is understood that the decoder module may be an MPEG-4 decoder, for example. It is also noted that the modules of the example embodiments of FIG. 1 include hardware, or software, or both that perform functions discussed herein. This hardware and/or software are within the purview of one of ordinary skill in the art, and thus are not described in detail so as to not obscure the description of the example embodiments.

In the system 100 an MPEG-2 bitstream 101 is input to an MPEG-2 decoder 102 decodes the bitstream 101. The decoder 102 outputs a decoded video signal (bitstream) 104, and coding information 103 from the bitstream 101. The coding information is input to a global indicator calculation module 106 as shown for further processing including the calculation of the GI in accordance with methods of example embodiments described herein. Optionally, a tap (not shown) provides a portion of the decoded video 105 to the GI calculation module 106 for further processing including calculation of the GI in accordance with methods of example embodiments.

The GI calculation module 106 includes hardware, or software, or both to calculate the GI by methods described herein. After the GI is calculated, a GI value 109 is input to a video processing module 107. Illustratively, the video processing module includes a video enhancement module 110, an artifact reduction module 111 and a noise reduction module 112.

As will become more clear as the present description continues, the modules 110-112 may process the decoded video in a particular order. It is noted that not only the order but the degree of processing can be also determined by GI as governed by the value of the GI 109 for each particular frame or portion(s) of a frame. It is noted that not all of the modules necessarily process the decoded video of each frame. For example, if the GI value for a frame indicates that there are significant artifacts, the video enhancement module 110 may not be employed as this would enhance the artifacts. Alternatively, the artifact reduction module 111 may be process the decoded video 105 before the video enhancement module 110 process the signal in order to reduce the chance of enhancing the artifacts.

The video processing module 107 and the modules of which it is comprised are known in the art. Such devices, being within the purview of the artisan of ordinary skill in the digital video processing art, are not described in detail so as to avoid obscuring the description of the example embodiments. However, it is noted that the metric of the example embodiments, the GI 109, ultimately provides feedback to these modules (110-112) about the quality of the coded video signal. As such modification of these modules may be necessary to adapt the modules for use with this novel metric.

Finally, after each of the modules 110-112 has processed the decoded video 104, a post processed video signal 108 is output.

FIG. 2 is a flowchart of a method of processing a coded digital video signal 200 in accordance with an example embodiment. The steps of the method 200 are usefully carried out in conjunction with a system such as the video processing system 100 described above. As such, reference may be made to the various components of the system 100 to illustrate and emphasize certain aspects of the present method.

Initially an input coded digital video signal (bitstream) 201 such as an MPEG-2 or other formatted bitstream is decoded at step 202 by a decoder module such as module 102 described above. Next, at step 203, the coding information is provided to a GI calculation module, such as module 106. In addition to this information's being provided at this step of the illustrative method, a portion of the decoded video bitstream may be provided. This decoded video may be useful in the calculation of the GI for a frame(s) in a subsequant step.

The GI calculation module calculates a GI value(s) for a particular frame at step 204. Illustrative calculation methods are described presently in connection with an example embodiment. However, as there are a plethora of parameters that may be used to determine the quality of the decoded video, it is emphasized that the illustrative methods are not intended to be limiting. Rather, in accordance with an example embodiments it is emphasized that a variety of other parameters may be used to calculate a global metric for a particular frame of a video that is indicative of the quality of the video in a relatively simple manner, and in real-time so that further video processing may be effected to improve the quality of the video of the frame.

In a first method, the GI value for a frame is calculated as the minimum value by:
GI_{frame}=min_{blockεframe}(num_bits/q_scale) eqn. (1)

In this example calculation, two parameters are used to form the GI value for a particular frame. To wit, the first factor, the q_scale, is indicative of how much quantization had to be applied to a particular macroblock (16×16 block of pixels), and is thus indicative of the degree of compression of the macroblock. As such, a smaller q_scale value is indicative of a good-quality video macroblock which does not have a significant degree of compression. Such a q_scale value may indicate that the macroblock is relatively easy to compress, and thus relatively free of blocking and ringing artifacts. Moreover, such a value indicates that a relatively small portion of the relevant information of the macroblocks has been lost to compression. Thus, by eqn. (1) a low such a q_scale value would tend to provide a relatively high GI value, indicative of a good video frame.

Alternatively, if the q_scale value is relatively high, the macroblock required a relatively high degree of compression, and a rather significant amount of relevant video information may have been lost in the compression process. Moreover, the macroblock may have a relatively large portion of blocking and ringing artifacts. Such a q_scale value would tend to provide a relatively low GI value, indicative of a low quality video frame.

The other factor, to which the GI is directly proportional, is the num_bits, or the number of bits used to encode per an 8×8 block. As can be appreciated, if there are a relatively large number of bits per block, there is more video information and likely a video block of good quality. It follows that if this value is relatively large, the quality of the frame is better, and likely has fewer artifacts are in the frame than a poor quality frame. If the num_bits is decreased, then the GI is constant. Assuming the same ‘scene’ content is decreased, the quality decreased. In this case there are likely more artifacts in the frame. This may be the case if the video was encoded in variable bit rate. Moreover, if the value of num_bits is a constant, the higher the q_scale (lower GI) the more likely there will be artifacts in the frame (and vice versa). Illustratively, this may be the incorporated for constant bit rate encoding.

Finally, it is noted that a plurality of GI values for selected regions of the frame may be determined via a modified version of eqn. (1). Thereby an average GI value may be determined and input to a video processing module for processing the decoded video. Alternatively, the individual GI values may be input to the video processing module, which selectively processes the decoded video of each individual region to effect the required processing (e.g., video enhancement, artifact reduction, noise reduction) for each region based on its individual requirements.

In accordance with another example embodiment, a global indicator may be calculated in step 204 by the following equation:
GI_{frame}=(no. blocks)⁻¹ Σ_{blockεframe}(num_bits/q_scale) eqn. (2)

Accordingly, eqn. (2) calculates an average of the quotient of (num_bits/q_scale) for the total number of blocks in a frame. This value is indicative of the average quality of the frame. As described in connection with the calculation of the GI via eqn. (1), the GI of the present example embodiment is input to the video processing module, and, based on its value, is used to select the type and appropriate degree of video processing that is applied to the decoded video to increase its quality. Like the GI values of the example embodiments, the greater the GI value from eqn. 2, the better the video quality, and thus the less artifact reduction, video processing, and possibly more sharpness enhancement that is required; and the lower the value the poorer the video quality, and more processing of the decode video of the frame may be required.

Like the example embodiments, equation (2) may be applied to a plurality of regions yielding a plurality of average values, one for each region. Eqn, (2) would be modified with the sum and the average being over the particular region, and not over the frame. These GI values may be used to calculate a more accurate average by averaging the individual values for each region, or as discussed above, may be used to process the decoded video for each region separately.

As stated, the parameters used and the computations applied in the example embodiments above are illustrative and not intended to limit the scope of possible embodiments. To this end, it is clear that one having ordinary skill in the art having reviewed the present disclosure will appreciate other parameters and computations within their purview that may be used to calculate a GI. These are intended to be within the purview of the present embodiments.

It is noted that in the present embodiments in which the video signal is a compressed MPEG-2 signal, these GI values may be calculated for the I (Intra) frames. For the P (Predictive) frames and B (Bi-directional) frames, either the GI value(s) calculated for the previous I-frame may be used, or the I frame's GI value(s) can be modulated to exploit the fact that the P and B frames generally have a slightly lower quality than the I-frame. Moreover, if a scene change occurs in a P or B frame, the GI can be reset by calculating one (or more) for the frame using only the intra-encoded blocks. In between the scene changes, the GI can be temporarily filtered with a low-pass filter to prevent sudden changes.

After the GI value(s) of the frame or regions is (are) calculated at step 204, it is transmitted to a video processing module 109, where it the video signal is processed using the GI value(s) as in step 205. As referenced previously, the value(s) of the GI is indicative of the quality of the decoded video of the particular frame or regions, and is/are incorporated by the modules 110-112 of the video processing module 109 in order to properly address deficiencies and defects in the decoded video signal. For example, if the GI value is low, there are likely artifacts present. The artifact reduction module would likely reduce these artifacts prior to any video enhancement, if any video enhancement is carried out at all. By way of another example, if the GI value is high, the quality of the decoded video is good, and relatively free of artifacts. In this case the artifact reduction is turned off and the video enhancement is carried out. If necessary, noise reduction may be carried out as well in these examples.

Finally, after the completion of step 205, the post-processed video signal is output at step 206.

In view of this disclosure it is noted that the various methods and devices described herein can be implemented in either software or hardware or a combination of the two to achieve a desired performance level. Further, the various methods and parameters are included by way of example only and not in any limiting sense. Therefore, the embodiments described are merely illustrative, and provide a global indicator for a frame or a number of regions of a frame. This global indicator may be input to a video processing module, which processes a decoded video bitstream based on the global indicator. In view of this disclosure, those skilled in the art can implement the various example devices and methods in determining their own processing of the decoded digital video, while remaining within the scope of the appended claims.

1. A method of processing a coded video signal, comprising:
decoding the coded video signal;
determining a global indicator value for a frame from coding information of a decoded video signal; and
providing video processing to the decoded video of the frame based on the global indicator.

2. A method as recited in claim 1, wherein the video processing consists essentially of: a video enhancement, an artifact reduction, and a noise reduction.

3. A method as recited in claim 1, wherein the global indicator is inversely proportional to a quantization parameter (q_scale).

4. A method as recited in claim 1, wherein the global indicator is proportional to a number of bits spent to code a luminance block (num_bits).

5. A method as recited in claim 1, wherein the global indicator is proportional to a number of bits spent to code a chrominance block.

6. A method as recited in claim 1, wherein the global indicator is an average of a plurality of global indicator values of regions of the frame.

7. A method as recited in claim 2, wherein the method further comprises, not performing the video enhancement based on a value of the global indicator indicative of a relatively large number of artifacts.

8. A method as recited in claim 2, wherein the method further comprises performing the video enhancement only after, if at all, performing the artifact reduction based on a value of the global indicator indicative of a relatively large number of artifacts.

9. A method as recited in claim 2, wherein the method further comprises not performing video enhancement step based on a based on a value of a global indicator indicative of a relatively high quality decoded video signal.

10. An apparatus for processing coded digital video signals comprising:
a coded video decoder module;
a metric calculation module; and
a video processing module, wherein the metric calculation module calculates at least one value of a global indicator, which indicates the quality of the coded video signal, and
wherein the metric calculation module provides the global indicator to the video processing module, which selectively processes the coded video signal depending on the value.

11. An apparatus as recited in claim 10, wherein the video processing module includes a video enhancement module.

12. An apparatus as recited in claim 10, wherein the video processing module includes an artifact reduction module.

13. An apparatus as recited in claim 10, wherein the global indicator is inversely proportional to a quantization parameter (q_scale).

14. An apparatus as recited in claim 10, wherein the global indicator is proportional to a number of bits spent to code a chrominance block.

15. An apparatus as recited in claim 10, wherein the global indicator is an average of a plurality of global indicator values of regions of the frame.

16. An apparatus as recited in claim 10, wherein each of the modules is implemented in hardware, or software, or both.

17. An apparatus as recited in claim 11, wherein video enhancement is not effected when a value of the global indicator is indicative of a relatively large number of artifacts.

18. An apparatus as recited in claim 10, wherein the video processing module performs a video enhancement step only after, if at all, performing an artifact reduction based on a value of the global indicator indicative of a relatively large number of artifacts.

19. An apparatus as recited in claim 10, wherein the apparatus is included in a video display device.

20. An apparatus as recited in claim 1, wherein the coded video is coded using one of MPEG-1, MPEG-2, MPEG-4 or MPEG-7.
